(19) United States
(12) Patent Application Publication
(10) Pub. No.: US 2017/0295125 A1
(43) Pub. Date: Oct. 12, 2017

(54) METHOD AND APPARATUS FOR THING COLLABORATION SERVICE BASED ON SOCIAL COMMUNITY

(71) Applicant: Electronics and Telecommunications Research Institute, Daejeon (KR)

(72) Inventors: Hoon Ki LEE, Daejeon (KR); Noh Sam PARK, Daejeon (KR)

(73) Assignee: Electronics and Telecommunications Research Institute, Daejeon (KR)

(21) Appl. No.: 15/481,002

(22) Filed: Apr. 6, 2017

(30) Foreign Application Priority Data
Apr. 11, 2016 (KR) 1020160044136

(51) Int. Cl. H04L 12/58; H04L 29/08

(52) U.S. Cl. CPC H04L 51/32; H04L 67/306; H04L 67/10; H04L 67/24

(57) ABSTRACT

The present disclosure relates to a method and apparatus for a thing collaboration service based on a social community. More specifically, the method includes: forming a social community among users having a purpose of detecting and preventing a risk in a predetermined place and environment; managing the social community to connect thing terminals owned by the individual users to each other on the basis of the formed social community; collecting thing status information from the thing terminal of each of the users; detecting an occurrence of a risk for predicting an occurrence of an accident or detecting a time point at which the accident occurs by analyzing the collected thing status information; and sharing information about the detected occurrence of the risk with the users of the social community.

### CROSS-REFERENCE TO RELATED APPLICATION

This application claims priority to and the benefit of Korean Patent Application No. 10-2016-0044136, filed on Apr. 11, 2016, the disclosure of which is incorporated herein by reference in its entirety.

### BACKGROUND

### 1. Field of the Invention

The present invention relates to a method and apparatus for a thing collaboration service based on a social community, and more specifically, to a method and apparatus which form a social community, prevent an occurrence of an accident, and provide a sharing service according to a type of a possible accident through a collaboration of things shared among users on the basis of the social community.

### 2. Discussion of Related Art

Recently, things are shared with things in the wearable forms which are shared with mobile terminals so that biometric information and context information of users are wirelessly collected through the Internet in real time. Such collected information can be collected as information related to a cause of an accident, and can be important information which can be used to determine an emergency situation.

However, the collected information is only known to a user and is not shared with other users. Thus, an immediate response to the cause of the accident can not be made.

Meanwhile, users having a social relationship (a social community) with each other can select a type of accident that can occur in an activity in a specific space, and can collect information according to a type of accident from things (smart phones, wearable devices, etc.) owned by each of the users. When information that predicts the occurrence of an accident according to each type of accident is detected or there is a possibility of an accident, a method of providing information according to a type of accident to users of a social community or a destination when the accident occurs.

It is urgently needed to provide an environment for a method of a thing collaboration service which consists of forming a social community in which social relationships are provided among users, collecting necessary information from things of users, detecting a risk for predicting and detecting the occurrence of an accident, and sharing the information with the social community.

### SUMMARY OF THE INVENTION

Embodiments of the present disclosure are directed to a method and apparatus for a thing collaboration service based on a social community, which allow a user to manage the occurrence of a risk and various risk factors, which may occur in a specific environment and place, by sharing risk factor and risk occurrence information with other users having the same purpose of an activity in the social community through the Internet of Things.

Embodiments of the present disclosure are directed to a method and apparatus for a thing collaboration service based on a social community, which allow a user using a plurality of things through the Internet of Things to collect and share information appropriate to the purpose of using a service (a specific service selected from a category of providable services) by connecting things registered by individual users of a social community which is formed in a specific place for the same purpose of the users.

According to one aspect of the present disclosure, there is provided a method of a thing collaboration service based on a social community, the method including: forming a social community among users having a purpose of detecting and preventing a risk in a predetermined place and environment; managing the social community to connect thing terminals owned by the users to each other on the basis of the formed social community; collecting thing status information from the thing terminal of each of the users; detecting an occurrence of a risk for predicting an occurrence of an accident or detecting a time point at which the accident occurs by analyzing the collected thing status information; and sharing information about the detected occurrence of the risk with the users of the social community.

The managing of the social community may include performing a user registration process so that the user of each of the thing terminals joins a previously formed social community or a newly formed social community as a member.

The managing of the social community may include registering the thing terminal of the user when a social relationship is formed, according to a presence or absence of the social relationship, and performing registration of the thing terminal through access verification when the thing terminal of the user is a thing terminal that is registerable according to a type of accident which is an attribute of the social community.

The managing of the social community may include managing a life cycle of the social community using member information of the social community, a social community profile, a user profile, and location information of the users and things.

The collecting of the thing status information may include collecting the thing status information of each of the thing terminals using restmap interface information and an attribute schema in a schema of a database for managing information on attributes and relationships of the things and the users.

The collecting of the thing status information may include collecting thing status information about at least one of biometric information, location information, and environment information of the user from each of the thing terminals.

The detecting of the occurrence may include determining a risk factor using a result of context analysis which detects a type of accident in a current environment and location collected from the thing terminal and a result of thing analysis from a user profile.

The sharing of the information may include sharing the information about the detected occurrence of the risk with the user of the thing terminal that detects the information about the occurrence of the risk and informing members of the social community of the information about the detected occurrence of the risk.

The method may further include removing a risk factor or performing a follow-up action after an accident occurs by transmitting the information about the detected occurrence of the risk to a corresponding external institution system when information about risk occurrence, of which frequency is predetermined times or higher, is detected or a risk management action is taken on the external institution system by a user according to the sharing of the social community.

The method may further include providing an action guidance service for each type of accident.

According to another aspect of the present disclosure, there is provided an apparatus for a thing collaboration service based on a social community, the apparatus including: a community manager configured to form a social community among users having a purpose of detecting and preventing a risk in a predetermined place and environment and connect thing terminals owned by the users to each other on the basis of the formed social community; an information collector configured to collect thing status information from the thing terminal of each of the users; an information analyzer configured to detect an occurrence of a risk for predicting an occurrence of an accident or detecting a time point at which the accident occurs by analyzing the collected thing status information; and an information sharer configured to share information about the detected occurrence of the risk with the users of the social community.

The community manager may perform a user registration process so that a user of each of the thing terminals joins a previously formed social community or a newly formed social community as a member.

The community manager may register the thing terminal of the user when a social relationship is formed, according to a presence or absence of the social relationship, and perform registration of the thing terminal through access verification when the thing terminal of the user is a thing terminal that is registerable according to a type of accident which is an attribute of the social community.

The community manager may manage a life cycle of the social community using member information of the social community, a social community profile, a user profile, and location information of the users and things.

The information collector may collect the thing status information of each of the thing terminals using restmap interface information and an attribute schema in a schema of a database for managing information on attributes and relationships of the things and the users.

The information collector may collect the thing status information about at least one of biometric information, location information, and environment information of the user from each of the thing terminals.

The information analyzer may determine a risk factor using a result of context analysis which detects a type of accident in a current environment and location collected from the thing terminal and a result of thing analysis from a user profile.

The information sharer may share the information about the detected occurrence of the risk with the user of the thing terminal that detects the information about the occurrence of the risk and may inform members of the social community of the information about the detected occurrence of the risk.

The information sharer may remove a risk factor or perform a follow-up action after an accident occurs by transmitting the information about the detected occurrence of the risk to a corresponding external institution system when information about risk occurrence, of which frequency is predetermined times or higher, is detected or a risk management action is taken on the external institution system by a user according to the sharing of the social community.

The information sharer may provide an action guidance service for each type of accident.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram of a system for an apparatus for a thing collaboration service based on a social community according to an embodiment of the present disclosure;

FIG. 2 is a configuration diagram for describing management of a life cycle of the social community according to the embodiment of the present disclosure;

FIG. 3 is a schema configuration diagram of a database for managing information on attributes and relationships of things and users according to an embodiment of the present disclosure;

FIG. 4 is a flowchart illustrating a method of social community formation and thing registration according to an embodiment of the present disclosure; and

FIG. 5 is a control flowchart illustrating a method of generating a social community and sharing information according to a type of accident according to an embodiment of the present disclosure.

### DETAILED DESCRIPTION OF EXEMPLARY EMBODIMENTS

Hereinafter, embodiments of the present disclosure will be described with reference to the accompanying drawings. A detailed description of the embodiments will be made focusing on what is necessary to understand operations and effects according to the present disclosure. Meanwhile, technical descriptions which are well-known in the art to which the present invention pertains and are not directly related to the present invention will be omitted in the following description. This is so the subject manner of the present disclosure is conveyed clearly without it being obscured by the omitted unnecessary descriptions.

In the descriptions of elements of the present disclosure, elements with the same name may be given different reference numerals in some drawings, and the elements may also be given the same reference numerals in different drawings. Even in such a case, pertinent elements may have different functions in the embodiment or the elements may have the same function in different embodiments. A function of each element should be understood based on the descriptions of each element in a corresponding embodiment.

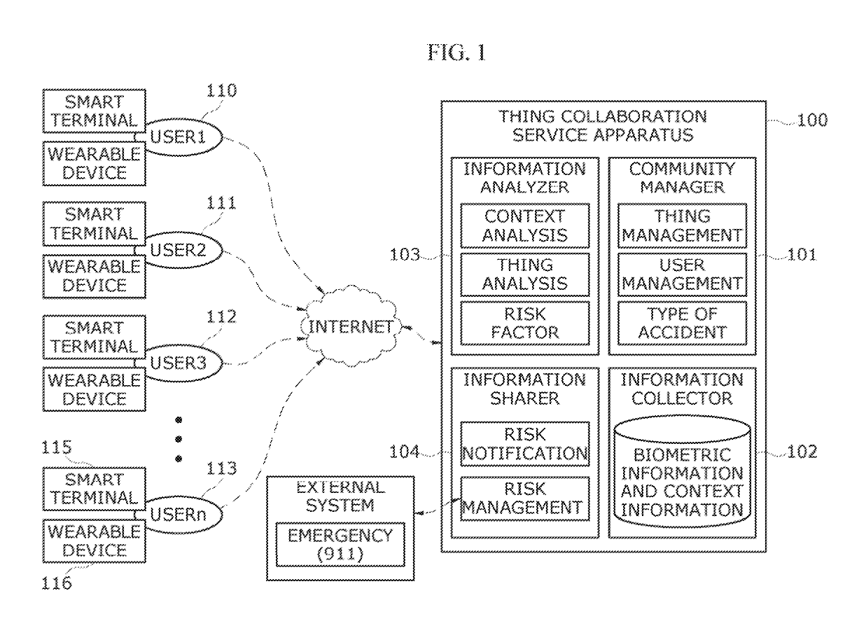

FIG. 1 is a configuration diagram of a system for an apparatus for a thing collaboration service based on a social community according to an embodiment of the present disclosure.

As shown in FIG. 1, a system for an apparatus 100 for a thing collaboration service based on the social community according to the embodiment of the present disclosure includes thing terminals of a plurality of users, the apparatus 100, and an external system 120.

Hereinafter, embodiments of an apparatus and method for forming a social community among users and collecting and processing information from things according to a type of accident that may occur in a specific place and environment will be described in detail with reference to the accompanying drawings.

Users form a social community to achieve the same goal in a specific place and environment. The social community may be formed through a social network or by joining a specific service. Various pieces of information are collected from the social community and the thing terminals (e.g., general devices capable of collecting various types of information, such as biometric information, location information, environment information, and the like) shared by each of the users. Therefore, a variety of information is collected as a basis for predicting that an accident may occur from various factors or for determining whether to take action when the accident occurs.

Users 110 to 113 have terminals, such as a smart terminal 115, which may approach a web through a mobile communication network or wireless communication in a general environment. Such a terminal interacts with a wearable device 116 through a short-range communication (generally Bluetooth) network.

Information on the smart terminal 115 and the wearable device 116 is integrally managed by the apparatus 100. When various risk factors are detected, the apparatus 100 performs a function of processing the risk factors.

As shown in FIG. 1, the apparatus 100 for a thing collaboration service based on the social community according to the embodiment of the present disclosure includes a community manager 101, an information collector 102, an information analyzer 103, and an information sharer 104.

The apparatus 100 for a thing collaboration service based on the social community according to the embodiment of the present disclosure provides information about a cause and occurrence of an accident when such information about the cause and occurrence of the accident needs to be shared in a specific space and place where there is a possibility of an accident using things shared with a plurality of users. In the embodiment of the present disclosure, a user may form a social community with multiple users having the same purpose in a specific environment or place, and may share a service and things for achieving the same purpose.

The apparatus 100 for a thing collaboration service based on the social community according to the embodiment of the present disclosure may collect a variety of information from a device of a user recognized as a thing terminal according to a type of accident which may occur in a specific environment and place, analyze the collected information, and provide the information when needed.

Hereinafter, a detailed configuration and operation of each element of the apparatus 100 for a thing collaboration service based on the social community of FIG. 1 will be described.

The community manager 101 forms a social community among users having a purpose of detecting and preventing a risk in a predetermined place and environment, and connects thing terminals owned by the users on the basis of the social community.

Here, the community manager 101 performs a user registration process so that a user may join a previously formed social community or a newly formed social community as a member. In addition, when a social relationship has been formed, the community manager 101 may register the user's thing terminal according to a determination of the presence or absence of the social relationship, and perform a thing terminal registration process through access authority verification when the thing terminal of the user is a thing terminal that may be registered according to a type of accident which is an attribute of the social community.

The community manager 101 may manage a life cycle of the social community using member information of the social community, a social community profile, a user profile, and user and thing location information.

Specifically, the community manager 101 manages meta-information about the users and thing terminals. The community manager 101 forms the social community and manages member users of the social community and attribute information about various thing terminals shared by the users.

The community manager 101 checks thing status information among attributes possessed by the thing terminal or manages information for controlling the thing terminal. In addition, the community manager 101 manages social relationship information of each user with socially related people and manages a variety of information related to relationship management.

In this case, an accident type includes types of accidents that may occur at specific places, and there are various types of accidents. Since data to be collected differs according to the various types of accidents, the community manager 101 defines and manages rules for data to be collected according to a type of accident and a processing method to be performed when an accident is detected or occurs.

Meanwhile, the information collector 102 collects thing status information from the thing terminal of each user. In this case, the information collector 102 may collect the thing status information of each of the thing terminals using restmap interface information and attribute schema in a schema of a database for managing information on attributes and relationships of things and users.

The information collector 102 may collect thing status information about at least one piece of biometric information, location information, and environment information of the user from each thing terminal.

Specifically, the information collector 102 stores a variety of data periodically collected from the community manager 101 through a control application programming interface (API) for thing interaction. The information collector 102 stores information collected from each thing and transmits the information to the information analyzer 103 to use the information in data analysis of accident types in various contexts.

Meanwhile, the information analyzer 103 detects an occurrence of a risk for predicting an occurrence of an accident or detecting a time point at which the accident occurs by analyzing the collected thing status information according to a type of accident. In this case, the information analyzer 103 may determine a risk factor using a result of context analysis which detects a type of accident in a current environment and a location collected from the thing terminal and a result of thing analysis from a user profile.

Specifically, the information analyzer 103 analyzes context according to a type of accident from the data collected by the information collector 102. The information analyzer 103 collects environmental factors from the information sharer 104, the smart terminal 115, or the wearable device 116 through a context analysis process and detects a current location based on Geo tagging information and a type of accident that may occur at the current location. The information analyzer 103 determines a variety of information that is compared with the user profile, such as a user's biometric information, and defined values through a thing analysis process. The information analyzer 103 determines risk factors, which vary for individual users, from profiling information. The information analyzer 103 detects a risk or determines whether to take action on the risk in the current context through analysis of risk factors which may occur in a current particular space and place on the basis of the variety of information collected from the context and things.

Meanwhile, the information sharer 104 shares information about the occurrence of a risk (hereinafter, referred to as “risk occurrence information”) detected by the information analyzer 103 with the users of the social community. In this case, the information sharer 104 shares the risk occurrence information with a user of a thing terminal that detects the risk occurrence information and informs the members of the social community of the risk occurrence information.

When the risk occurrence information, of which frequency is predetermined times or higher, is detected or a risk management action is taken on an external institution system by a user according to sharing among the social community, the information sharer 104 may remove a risk factor or perform a follow-up action after an accident occurs by transmitting the risk occurrence information detected by the information analyzer 103 to the corresponding external institution system.

In addition, the information sharer 104 may provide an action guidance service for each type of accident on the basis of each step.

Specifically, the information sharer 104 transmits a processing result of the information analyzer 103 to the social community or another external system 120. That is, the information sharer 104 notifies of a risk or the processing of a detected risk by notifying the external system 120 in response to the risk. The information sharer 104 does not notify of a risk factor immediately upon detecting the risk factor occurring, but transmits the risk factor according to n^{th} detection of a risk. When a situation having a level higher than a specific level for informing a user belonging to the social community of the risk detection is detected, the external system 120 transmits the risk detection to the user to immediately remove the risk factor.

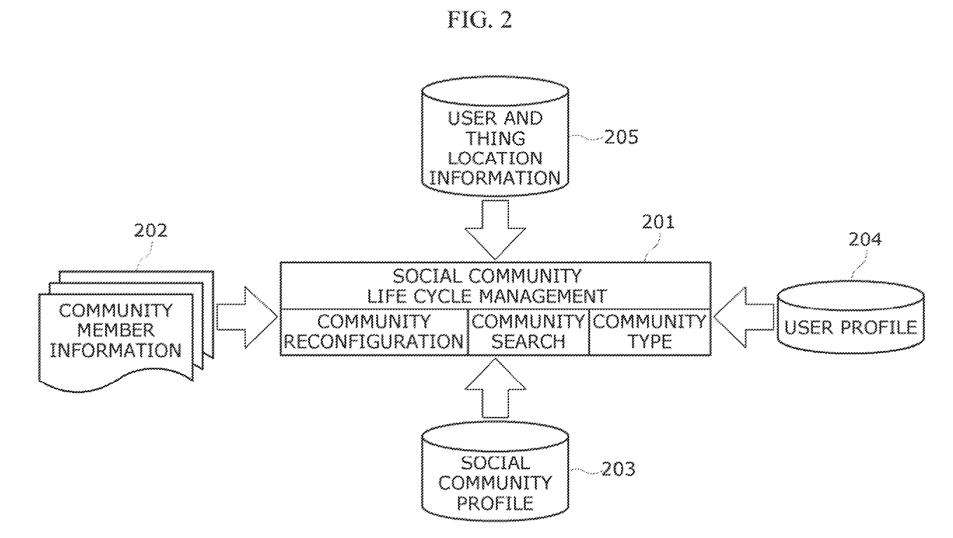

FIG. 2 is a configuration diagram for describing management of a life cycle of the social community according to the embodiment of the present disclosure.

As shown in FIG. 2, in order to collect and control information from a thing terminal through thing collaboration, information related to authorization and authentication of thing access is required from an owner of the thing terminal. A function of life cycle management for managing such information and a social community formed in a specific place and environment is provided in the embodiment of the present disclosure.

Although there is generally a continuous creation cycle of a social community, a life cycle manager 201 in the embodiment of the present disclosure dynamically forms a social community with a common purpose in a specific environment and context and maintains the social community only for a sustainable period of time. Since social relationships among multiple users are formed in the social community, the social community is dynamically reconfigured according to users or things. In the case where a plurality of social communities are present, a function of searching for and joining social communities formed in the same context or environment is provided. In addition, types of social communities are divided into different types of risks according to areas or environments. A social community profile 203 for each type of social community is managed so that the types of social communities may be maintained identically to types that form the social communities.

Information about the above types of social community is basically generated using users and thing location information 205. Whether a user or a thing is valid is determined according to the current location and place, and whether the user or the thing is joinable or sharable is determined.

Community member information 202 includes a variety of information according to a relationship type because a social relationship may be a real relationship or may be formed at a place and space for a common purpose. A user profile 204 is provided to manage a basic profile and biometric information required for risk detection. For example, since average blood pressure may vary from one person to another, the average blood pressure may be profiled and utilized as a level of risk perception. The social community profile 203 is configured to store a purpose of forming a social community and a variety of information, which are utilized as data for determining search or analysis according to a type of the social community.

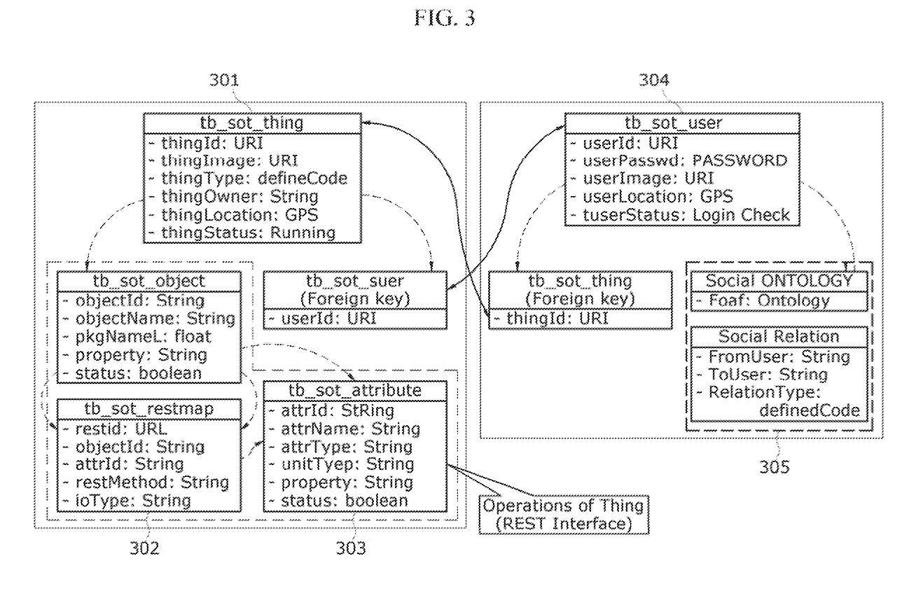

FIG. 3 is a schema configuration diagram of a database for managing information on attributes and relationships of things and users according to an embodiment of the present disclosure.

A social community in which relationships between users are formed is formed, and thing information is shared according to information on the formed relationships.

As shown in FIG. 3, a configuration of a database for managing the above information is provided.

A thing attribute 301 is a schema for basically storing basic attributes of a thing from meta-information. The thing attribute 301 is configured to manage fixed data about a location, status, and type of a thing.

In addition, restmap interface information 302, which is used for a REST API call, is managed as meta-information for controlling a thing. The restmap interface information 302 is configured to store basic information of an interface which fetches data collected by the thing from the web.

Information about a method of generating an API through an attribute schema 303 is stored. Since interfaces provided in things are different from each other and different information may be required for each interface, the interfaces and information are managed as separate information for each thing so that various things may be effectively assessed and necessary information may be collected.

User information 304 is configured to store basic information data and relation information 305 configured to manage social relationships among users. The relation information 305 defines a type of relationship among users and provides a method of forming a social community according to a predefined type.

That is, FIG. 3 illustrates a database about users and things for forming a social community. From the data collected based on the users and things, a risk detection and risk discovery process according to a type of risk may be performed.

A method of a thing collaboration service based on the social community according to the embodiment of the present disclosure includes forming a social community among users having the same purpose in an initial specific place and environment, connecting smart terminals 115 owned by individual users on the basis of the formed social relationship, predicting the occurrence of an accident and detecting a time point at which an accident occurs from information collected according to types of accidents, transmitting generated information to the users through the social community so that the information may be shared, and providing an action guidance service for a type of accident on the basis of a series of steps.

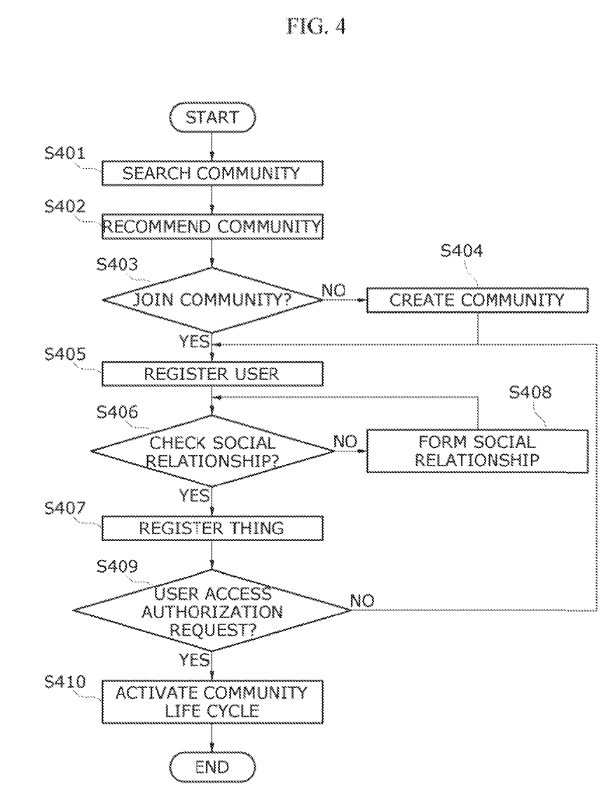

FIG. 4 is a flowchart illustrating a method of social community formation and thing registration according to an embodiment of the present disclosure.

First, users form a community for the same purpose (detecting and preventing a risk) in a specific context and place.

The community manager 101 inputs a variety of search information, such as basic information for forming the community and a risk type associated with the community (S401).

Then, the community manager 101 checks whether the formed community has the same purpose and type as currently registered communities and recommends a community of a similar type (S402).

The community manager 101 checks whether a user joins the recommended community (S403).

When the result of checking (S403) indicates that the user has not joined the recommended community, the community manager 101 creates a new community (S404).

When the result of checking (S403) indicates that the user has joined the recommended community, the community manager 101 performs a user registration process so that the user joins a previously formed community or a new community as a member (S405).

In the case of a new join, the user registration process (S405) does not require a determination of the presence or absence of a social relationship with existing members, but when the user joins a previously formed community, a check process for forming a social relationship is required (S406).

According to the determination of the presence or absence of social relationships with previously formed communities, the community manager 101 registers the user's thing so that the thing may be shared when a social relationship is formed (S407). In this case, the community manager 101 checks whether the thing is a thing terminal registerable in the registration process according an accident type which is an attribute of the community.

When the thing is registerable, the community manager 101 checks an access authorization request for whether the thing terminal is sharable with the community members (S409).

When the result of checking the access authorization request (S409) indicates that the access is confirmed, the community manager 101 performs re-configuration of a life cycle of the corresponding community and activates newly joined users (S410).

Conversely, when the result of checking the access authorization request (S409) indicates that the access is not confirmed, the community manager 101 performs the user registration process (S404).

As described above, when the social relationship has not been established, a new relationship is formed through a social relationship establishment process (S408), and when the establishment is complete, activation of the user as a member of the community is performed through a thing registration and access authorization check.

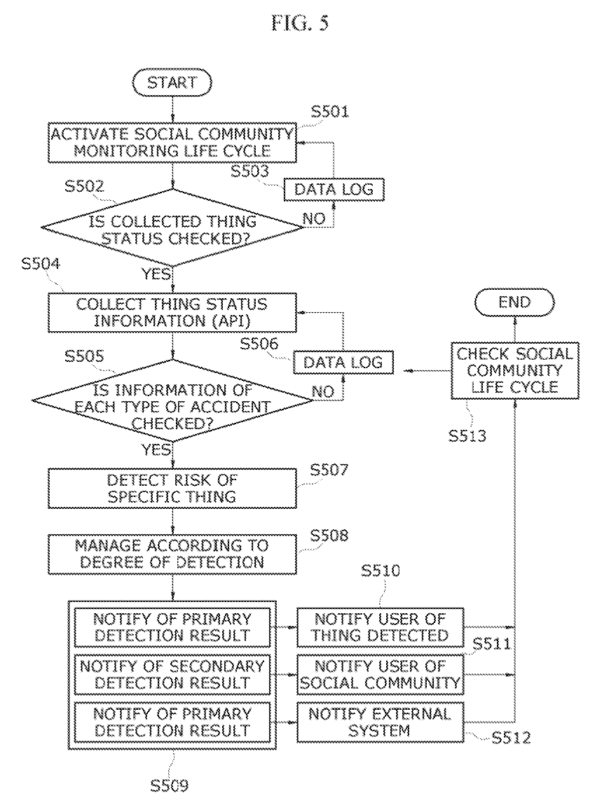

FIG. 5 is a control flowchart illustrating a method of generating a social community and sharing information according to a type of accident according to an embodiment of the present disclosure.

A method of a thing collaboration service based on the social community according to the embodiment of the present disclosure may create a social community and process an accident according to a type of accident on the basis of thing status information collected through the social community. (“ [symbol] ” [symbol] )

After the social community is formed, detection is started through a life cycle (S501).

The information collector 102 checks a status of a thing of each member of the social community (S502).

The information collector 102 checks whether the thing is in a valid state in which the state of a thing terminal is detectable, and when the check result (S502) indicates that the thing is in a state in which information collection is impossible, the information collector 102 requests that a user having an authority of each thing changes the thing to the valid state (S503).

When the status of each thing is checked in the check process (S502), the information collector 102 periodically collects thing status information according to a life cycle of the social community after confirming the status of each thing (S504). In this case, an API may collect the thing status information of each thing terminal using the restmap interface information 302 and the attribute schema 303 shown in FIG. 3.

The information collector 102 checks whether the collected thing meets a perception condition of each type of accident (S505).

When the result of checking (S505) indicates that the condition is not satisfied, that is, the collected status information is not information for each type of accident, the information collector 102 stores the collected information (S506).

Subsequently, the checking of information for each type of accident is processed by the information analyzer 103 when the thing status information is collected on the basis of a type of condition and profile information of each user and the social community is formed.

Conversely, when the result of checking (S505) indicates that the condition is satisfied, that is, when a risk is detected by analyzing information for each type of accident, the information analyzer 103 examines a detailed state of a condition under which a specific thing is detected (S507).

Then, when information that satisfies the accident type condition is collected without the user making a mistake or peculiarity of context, the information analyzer 103 performs an action according to the information (S508).

Then, the information sharer 104 performs step-wise risk processing to notify a result of an n^{th} notification detection (S509).

Also, the information sharer 104 transmits a first collected risk notification to an owner of a corresponding thing and collects a result of managing a corresponding risk from the owner (S510). Such step-wise actions are performed to determine a level of detection for notifying members of the social community when a minor accident is detected.

When a risk or risk detection is conformed by the thing status information collection process (S504 to 506) being performed multiple times, the information sharer 104 transmits a risk notification to a user of the social community according to a result of a secondary detection so that the information may be shared (S511). Through the risk detection, the members of the social community are informed of the risk, thereby promoting quick management or preventing the occurrence of another risk.

When a higher level of risk detection occurs or a risk management action by a user according to sharing among the social community occurs on the external system 120, the information sharer 104 may transmit the risk occurrence information to a corresponding institution system so that risk factors are removed or follow-up actions are performed according to the occurrence of an accident (S512).

Thereafter, the information sharer 104 checks the life cycle of the social community and repeatedly performs the thing status information collection process (S504 to S506) or completes the information sharing process according to the accident type (S513).

Various types of information, such as biometric information of a user or phase difference information (a fall due to an instant change in height or the like) of smart terminals, are collected and separate management may be performed for each of the collected pieces of information according to a level of detection.

Risk detection information, a follow-up processing result, and the like are collected according to a life cycle of a social community, and the accumulated information may be applied to other communities.

According to the embodiment of the present disclosure, things of users are shared through a social relationship according to various types of accidents, a cause of an accident according to a type of accident is predicted or detected from the shared information, and information is shared through the things constituting a social community, thereby making it possible to provide a service for preventing an accident or notifying of an accident when it occurs.

In addition, according to the embodiment of the present disclosure, a social community can be dynamically formed as needed among users having the same purpose in a specific environment or a place where an accident can occur instead of a normal environment, a variety of information (e.g., biometric information, context information of an environment, etc.) can be collected from each thing terminal registered by each user of the community, and various types of information obtained by determination and prediction may be shared. In this case, information about a risk in a specific environment or a place where an accident can occur is shared as soon as possible, thereby making it possible to effectively provide a service for managing risk.

It should be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of a thing collaboration service based on a social community, the method comprising:
forming a social community among users having a purpose of detecting and preventing a risk in a predetermined place and environment;
managing the social community to connect thing terminals owned by the users to each other on the basis of the formed social community;
collecting thing status information from the thing terminal of each of the users;
analyzing the collected thing status information and detecting an occurrence of a risk for predicting an occurrence of an accident or detecting a time point at which the accident occurs; and
sharing information about the detected occurrence of the risk with the users of the social community.

2. The method of claim 1, wherein the managing of the social community includes performing a user registration process so that the user of each of the thing terminals joins a previously formed social community or a newly formed social community as a member.

3. The method of claim 1, wherein the managing of the social community includes registering the thing terminal of the user when a social relationship is formed according to a presence or absence of the social relationship, and performing registration of the thing terminal through access verification when the thing terminal of the user is a thing terminal that is registerable according to a type of accident which is an attribute of the social community.

4. The method of claim 1, wherein the managing of the social community includes managing a life cycle of the social community using member information of the social community, a social community profile, a user profile, and location information of the users and things.

5. The method of claim 1, wherein the collecting of the thing status information includes collecting the thing status information of each of the thing terminals using restmap interface information and an attribute schema in a schema of a database for managing information on attributes and relationships of the things and the users.

6. The method of claim 1, wherein the collecting of the thing status information includes collecting the thing status information about at least one of biometric information, location information, and environment information of the user from each of the thing terminals.

7. The method of claim 1, wherein the detecting of the occurrence includes determining a risk factor using a result of context analysis which detects a type of accident in a current environment and location collected from the thing terminal and a result of thing analysis from a user profile.

8. The method of claim 1, wherein the sharing of the information includes sharing the information about the detected occurrence of the risk with the user of the thing terminal that detects the information about the occurrence of the risk and informing members of the social community of the information about the detected occurrence of the risk.

9. The method of claim 1, further comprising removing a risk factor or performing a follow-up action after an accident occurs by transmitting the information about the detected occurrence of the risk to a corresponding external institution system when information about risk occurrence, of which frequency is predetermined times or higher, is detected or a risk management action is taken on the external institution system by a user according to the sharing of the social community.

10. The method of claim 1, further comprising providing an action guidance service for each type of accident.

11. An apparatus for a thing collaboration service based on a social community, the apparatus comprising:
a community manager configured to form a social community among users having a purpose of detecting and preventing a risk in a predetermined place and environment and connect thing terminals owned by the users to each other on the basis of the formed social community;
an information collector configured to collect thing status information from the thing terminal of each of the users;
an information analyzer configured to analyze the collected thing status information and detect an occurrence of a risk for predicting an occurrence of an accident or detecting a time point at which the accident occurs; and
an information sharer configured to share information about the detected occurrence of the risk with the users of the social community.

12. The apparatus of claim 11, wherein the community manager performs a user registration process so that the user of each of the thing terminals joins a previously formed social community or a newly formed social community as a member.

13. The apparatus of claim 12, wherein the community manager registers the thing terminal of the user when a social relationship is formed according to a presence or absence of the social relationship, and performs registration of the thing terminal through access verification when the thing terminal of the user is a thing terminal that is registerable according to a type of accident which is an attribute of the social community.

14. The apparatus of claim 11, wherein the community manager manages a life cycle of the social community using member information of the social community, a social community profile, a user profile, and location information of the users and things.

15. The apparatus of claim 11, wherein the information collector collects the thing status information of each of the thing terminals using restmap interface information and an attribute schema in a schema of a database for managing information on attributes and relationships of the things and the users.

16. The apparatus of claim 11, wherein the information collector collects the thing status information about at least one of biometric information, location information, and environment information of the user from each of the thing terminals.

17. The apparatus of claim 11, wherein the information analyzer determines a risk factor using a result of context analysis which detects a type of accident in a current environment and location collected from the thing terminal and a result of thing analysis from a user profile.

18. The apparatus of claim 11, wherein the information sharer shares the information about the detected occurrence of the risk with the user of the thing terminal that detects the information about the occurrence of the risk and informs members of the social community of the information about the detected occurrence of the risk.

19. The apparatus of claim 11, wherein the information sharer removes a risk factor or performs a follow-up action after an accident occurrence by transmitting the information about the detected occurrence of the risk to a corresponding external institution system when information about risk occurrence, of which frequency is predetermined times or higher, is detected or a risk management action is taken on the external institution system by a user according to the sharing of the social community.

20. The apparatus of claim 11, wherein the information sharer provides an action guidance service for each type of accident.
